(19) United States
(12) Patent Application Publication
(10) Pub. No.: US 2023/0257931 A1
(43) Pub. Date: Aug. 17, 2023

(54) Method of Coating a Three-Dimensional Fabric and the Inflatable Product Made Thereof

(71) Applicant: Tomlong Techstile Corporation, TAICHUNG CITY (TW)

(72) Inventor: Ming-Hsien Wu, Taichung City (TW)

(21) Appl. No.: 18/303,787

(22) Filed: Apr. 20, 2023

Related U.S. Application Data
(63) Continuation-in-part of application No. 16/699,069, filed on Nov. 28, 2019, now abandoned.
(60) Provisional application No. 62/780,334, filed on Dec. 17, 2018.

(30) Foreign Application Priority Data
Jul. 31, 2019 (TW) 108127299

(51) Int. Cl. D06M 15/564; D06B 23/24; B32B 7/12; B32B 5/26; B32B 37/12

(52) U.S. Cl. CPC D06M 15/564; D06B 23/24; B32B 7/12; B32B 5/26; B32B 37/12; D06M 2200/12; B32B 2307/7242; B32B 2307/7265; B32B 2255/02; B32B 2255/26; B32B 2037/1253; B32B 2305/18

(57) ABSTRACT

A method of coating a three-dimensional fabric has the steps of: preparing a three-dimensional fabric having two fabric layers and a plurality of vertical yarns connected between the two fabric layers; guiding the three-dimensional fabric with the two fabric layers vertically in the horizontal plane to an coating space, when the three-dimensional fabric moves in the coating space, a tension on the surface of the two fabric layers is between 5 and 25 kilograms (kg); applying an adhesive to the surface of the two fabric layers, and the adhesive spreading vertically and fluidly; and providing a reaction condition such that the adhesive dries into a film and forms a bonding layer.

### FIELD OF THE INVENTION

A coating method, more particularly, a method of coating a three-dimensional fabric and the inflatable product made thereof.

### BACKGROUND OF THE INVENTION

Structurally, in addition to two fabric layers arranged in up and down positions, the common three-dimensional fabric also has a plurality of vertical yarns in the middle of the two fabric layers to fix the distance between them. This three-dimensional fabric is widely used in inflatable products of air storage, such as: inflatable beds for buffering and protection, inflatable water boats, etc. When the inflatable product is filled with gas between the two fabric layers, the plurality of vertical yarns of the three-dimensional fabric will be in a state of vertical tension to achieve the supporting effect in the thickness direction as well as the effect of surface flatness.

In order to ensure the waterproofness of the inflatable product, in the current manufacturing technology, the three-dimensional fabric is usually laid out on the production line, and an adhesive is applied to the surface of one of the layers of the three-dimensional fabric using a coating member, then the three-dimensional fabric is turned and laid flat again, and then the adhesive is applied to the surface of another fabric layer. However, this coating method often has the following disadvantages:
1. Both surfaces of the three-dimensional fabric must be turned over to apply the adhesive, making the process repetitive and time-consuming;
2. When the upper layer of the fabric is coated with the adhesive, the stiffness of the upper layer of the fabric is increased compared to the uncoated lower layer, the stiffness of the two layers is significantly different, and the tension is also different. In addition, there are a plurality of vertical yarns of length between the upper layer and the lower layer of the three-dimensional fabric, which may cause the upper layer to move against the lower layer along the direction of the coating member during coating and after coating, resulting in the upper layer and the lower layer of the three-dimensional fabric becoming wrinkled.

Therefore, the development of an adhesive coating method suitable for three-dimensional fabrics and their inflatable support products has become an important topic of current research.

### SUMMARY OF THE INVENTION

In order to overcome the repetitive, tedious, time-consuming, poor coating efficiency and poor quality of the above-mentioned inflatable products in the current manufacturing technology, the present invention provides a method for coating adhesive to three-dimensional fabrics, comprising the steps of:
preparing a three-dimensional fabric having two fabric layers and a plurality of vertical yarns connected between the two fabric layers;
guiding the three-dimensional fabric with the two fabric layers vertically in the horizontal plane to a coating space, wherein when the three-dimensional fabric moves in the coating space, a tension on the surface of the two fabric layers is between 5 and 25 kilograms (kg);
applying an adhesive to the surface of the two fabric layers, and the adhesive spreading vertically and fluidly; and
providing a reaction condition such that the adhesive dries into a film and forms a bonding layer.

The inflatable product provided by the present invention has the following advantages in manufacture:
1. By guiding the three-dimensional fabric vertically, the space occupied by horizontally transporting the three-dimensional fabric can be effectively saved.
2. By coating the adhesive vertically, not only can both sides of the three-dimensional fabric be coated at the same time, but the adhesive can also be spread vertically and fluidly, saving the coating process and time.
3. As the surface of the two fabric layers moves under tension, the two fabric layers can be spread flat, which helps to improve the quality of adhesive coating.
4. As the surface of the two fabric layers moves under tension, when the adhesive is applied, the two fabric layers will not move with mutual displacement along the coating direction.
5. Two fabric layers can be coated with the adhesive at the same time, so that the two fabric layers have the same rigidity, which helps to uniformly control the tension during the movement of the three-dimensional fabric and strengthens the flatness of the surface after coating.

The inflatable products provided by the present invention can be used in protective textiles, inflatable motorboats, temporary docks, buffer protective textiles, emergency ambulance docks, inflatable beds, stand-up paddles and jackets, and other inflatable protective materials and construction materials. By processing lighter and thinner adhesive coating, it is expected to solve the problems of traditional manual coating, slow production speed and uneven quality.

### BRIEF DESCRIPTION OF THE DRAWINGS

FIG. 1 is a three-dimensional schematic view of the first preferred embodiment of the present invention;

FIG. 2 is a side view of the first preferred embodiment of the present invention;

FIG. 3 is a side view of the second preferred embodiment of the present invention; and

FIG. 4 is a sectional side view of the preferred manufacturing embodiment of the present invention.

### DESCRIPTION OF THE PREFERRED EMBODIMENTS

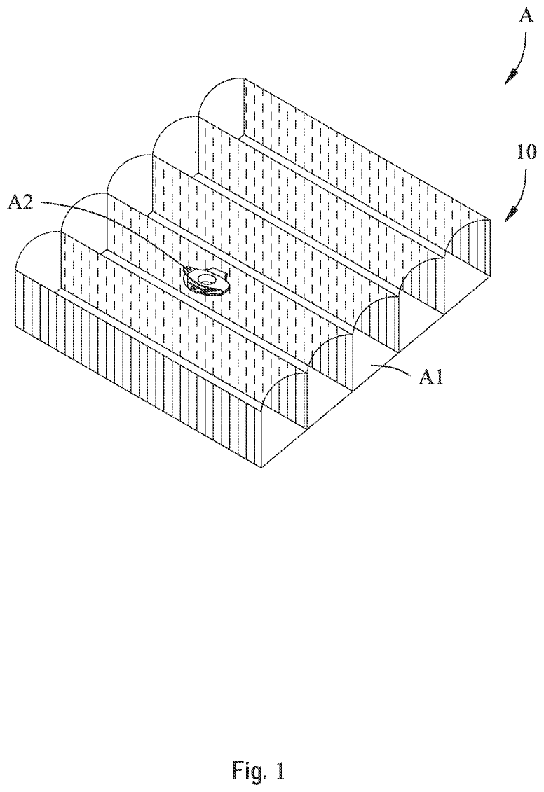

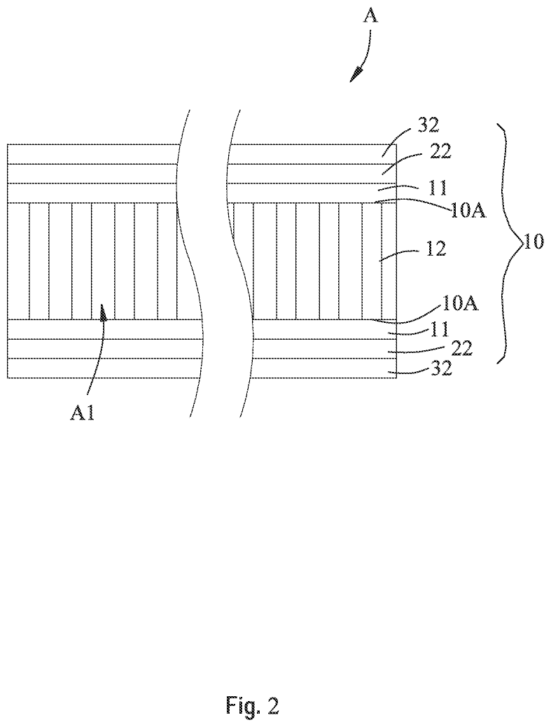

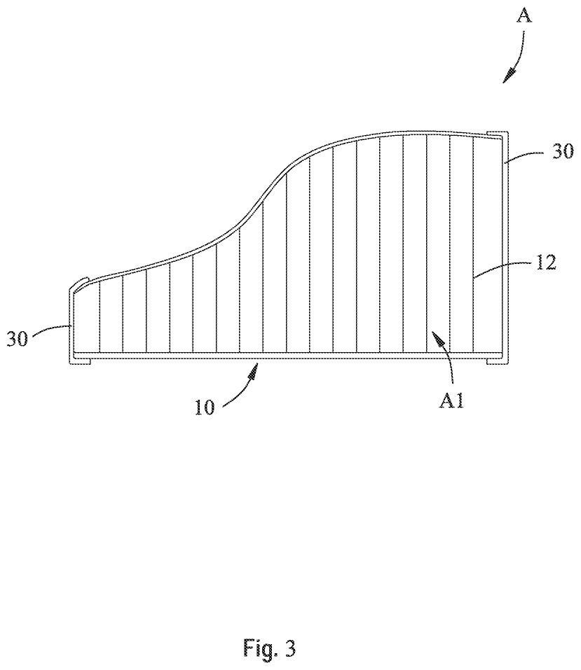

FIGS. 1 to 3 illustrate the first and second preferred embodiments of the present invention. In the present invention, the dimensions and proportions of the layers and undivided areas in the drawings may be exaggerated for clarity.

Referring to FIGS. 1 to 3, which are preferred embodiments of the inflatable product A provided by the present invention. The inflatable product A comprises a three-dimensional fabric 10 and a cladding film 30 surrounds the three-dimensional fabric. The three-dimensional fabric 10 comprises two fabric layers 11 positioned up and down and a plurality of vertical yarns 12 connected between the two fabric layers 11, wherein the maximum distance between the two fabric layers 11 when the three-dimensional fabric 10 is expanded is limited by the length D of the plurality of vertical yarns 12.

The cladding film 30 is in the form of a sheet and surrounds the side of the three-dimensional fabric 10 and wraps two fabric layers 11 therebetween. At least a part of the two edges of the cladding film 30 correspond to the two fabric layers 11, respectively, and are bonded to the ring of the three-dimensional fabric 10 so that an inflatable space A1 can be defined between the three-dimensional fabric 10 and the cladding film 30. Air can enter the inflatable space A1 through an air intake position A2 on the inflatable product A, and when the inflatable space A1 is filled with the air, the three-dimensional fabric 10 is expanded and the two fabric layers 11 are provided at the maximum distance from each other.

The fabric layer 11 has the properties of being strong, wear resistant, thick, tough and air blocking. The fabric layer 11 is not limited in fiber material or weaving method, but preferably the fabric layer 11 includes a tensile strength range between 1000 and 2000 Newtons (N), a denier range between 100 and 1000 Dan (D), and a warp per inch (wpi) between 30 and 100 warp yarns per inch; and a fillings per inch (fpi) between 20 and 80 warp yarns per inch.

The length of the plural vertical yarns 12 is not limited, but can be set according to the thickness of the inflatable product, and further, the number of the plural vertical yarns 12 is not limited in their length to be the same, but can be set according to the needs of each part of the inflatable product to connect the plural vertical yarns 12 of different lengths between the two fabric layers 11 so that the inflatable product can have a three-dimensional shape. Preferably, the length of the vertical yarns 12 is between 5 and 60 centimeters (cm).

In order to make the plural vertical yarns 12 supportive, a yarn tension range of the vertical yarns 12 is preferably between 30 kilograms per 25 square centimeters (kg/cm2) and 250 kilograms per 25 square centimeters (kg/cm2), so that when the inflatable space A1 is filled with air, each of the vertical yarns 12 can not only display the thickness of the inflatable product A but also have a supportive effect.

Furthermore, the arrangement of the two fabric layers 11 above and below the vertical yarn 12 is also not limited, but can be set at different distances between the vertical yarns 12. For example, when the distance between the vertical yarns 12 is larger, the inflatable product A is easier to press with a smaller force and can exhibit a softer and more supple tactile sensation in response to the pressure deformation; when the distance between the vertical yarns 12 is smaller, the inflatable product A is harder to press with a larger force and can exhibit a more rigid supporting effect. Thus, the inflatable product can adjust the distance between the vertical yarns 12 in each part/area to design an inflatable product that conforms to the ergonomics or shape of a user's body. Preferably, the distance between the vertical yarns 12 ranges from 0.8 to 20 centimeters (cm). Furthermore, in present embodiment, in order to meet the efficiency and convenience of industrial production, the vertical yarns 12 are first set in rows with the above-mentioned distance range and then distributed between the upper and lower fabric layers 11 with a distance range of 5 to 10 centimeters (cm) between the rows.

In order to ensure the inflatable product A has the function of waterproofing and air blocking, the upper and lower fabric layers 11 further include a bonding layer 22 and a combining layer 32 in sequence with respect to a surface 10A of the vertical yarns 12.

The bonding layer 22 is formed by an air drying or heat drying adhesive. The adhesive material may be a thermosetting polyurethane (PU) or a hot melt adhesive.

Wherein the adhesive may be a solvent-based single-liquid adhesive or a two-liquid adhesive, for example the adhesive may be selected from a group consisting of a polyurethane resin, 5 phr to 70 phr dimethylformamide, and 1 phr to 50 phr methyl ethyl ketone, with 0.1 phr to 40 phr of a bridging agent added. In addition, the adhesive may include a solvent-free single-liquid adhesive or a two-liquid adhesive formed, for example, by mixing a thermoplastic polyurethane resin with a bridging agent.

A viscosity modifier may also be added to the adhesive, if desired, such that the adhesive viscosity ranges from 5,000 to 100,000 centipoise (cps), wherein the viscosity modifier may include acetone, isobutanol, glycol ether, butanone, ethyl acetate, or dimethylformamide.

Furthermore, in accordance with the description of the preceding paragraph, the setting of the warp per inch and the fillings per inch of the fabric layer 11 can not only help the fabric layer 11 to exhibit the strength characteristics of preventing soaking and increasing the strength of being strong, wear-resistant, thick and tough, but also further prevent the bonding layer 22 from penetrating into the fabric layer 11 when it is set on the surface 10A in a flowing state.

The combining layer 32 is a waterproofing and air blocking fabric which may be made of thermoplastic polyether polyurethane/thermoplastic polyester polyurethane (TPU) or polyvinylchloride (PVC), rubber or other elastomers. It should be noted that the combining layer 32 is provided on the surface 10A with the aid of the bonding layer 22, and if the bonding layer 22 is not applied, the combining layer 32 may easily peel off from the surface 10A and affect the service life of the inflatable product A.

Further, in order to provide the inflatable product A with properties such as antibacterial, non-slip, thermal conductivity, flame retardant, improved surface strength, aesthetic appearance, foam structure, etc., other functional additives such as antibacterial agent, electrical conductivity agent, flame retardant, surface reinforcing agent, foaming agent, UV absorber or color powder may be added to the material of the bonding layer 22 and/or the combining layer 32.

Wherein the amount of antimicrobial additive may be between 0.001 and 5 per 100 grams of resin (phr); non-slip additives may be between 1 and 50 per 100 grams of resin (phr); thermal conductivity additives may be between 1 and 50 per 100 grams of resin (phr); flame retardant additives may be between 1 and 50 per 100 grams of resin (phr); surface abrasion resistant additives may be between 1 and 20 per 100 grams of resin (phr); foaming additives may be between 1 and 20 per 100 grams of resin (phr) or physical foaming; UV absorbing additives may be between 1 and 5 per 100 grams of resin (phr); and color powder additives may be between 1 and 20 per 100 grams of resin (phr).

Further, silicate, calcium carbonate, talc, wollastonite, silicon dioxide, mica, clay, or high air blocking polymers may be also added to improve the air blocking properties of the inflatable product.

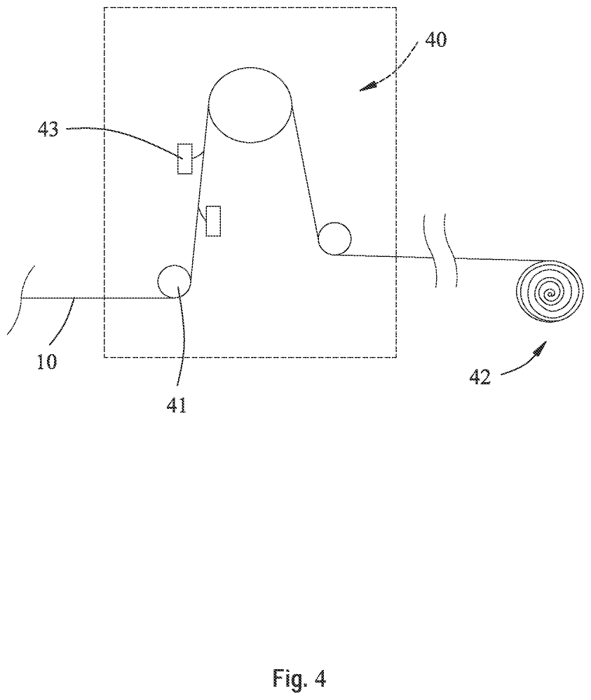

With reference to FIG. 4, the present invention further provides the manufacturing method of the inflatable product A comprising the steps of:

S1. Preparing the three-dimensional fabric 10 having two fabric layers 11 positioned at the top and bottom, and a plurality of vertical yarns 12 connected between the two fabric layers 11. Wherein the three-dimensional fabric 10 may be in the form of a continuous web or a segment cut in advance;

S2. Guiding the three-dimensional fabric 10 to a coating space 40 with two such fabric layers 11 vertically in the horizontal plane. Wherein the three-dimensional fabric 10 moves in the coating space 40 with a tension between 5 and 25 kilograms (kg) on the surface of the two fabric layers 11. Thereby, due to the tension, the two fabric layers 11 are close to each other so that the plural vertical yarns 12 are curled and flattened between the two fabric layers 11. In present embodiment, the three-dimensional fabric 10 is in the form of a continuous web, and at least one guide roller 41 can be used in the coating space 40 to guide the three-dimensional fabric 10 into or out of the coating space 40. Wherein the speed of the three-dimensional fabric 10 moving in the coating space 40 is greater than 2 meters per minute (m/min). Further, a rewinding device 42 is provided for rewinding the three-dimensional fabric 10 after it leaves the coating space 40. The rewinding device 42 can also act as a tension control device to control the tension of the fabric layers 11 as the three-dimensional fabric 10 moves in the coating space 40;

S3. Applying the adhesive to the surface 10A of the two fabric layers 11, and it should be noted that the three-dimensional fabric 10 is guided vertically in the horizontal plane by the two fabric layers 11, and the two fabric layers 11 are moved under tension. When coating, the adhesive may be applied to the surface 10A of the two fabric layers 11 of the three-dimensional fabric 10 simultaneously or separately. In addition, since the two fabric layers 11 of the three-dimensional fabric 10 are moved under tension, the two fabric layers 11 of the fabric will not move with mutual displacement due to the same coating direction in the process of coating. Wherein, the coating method is not limited, and it can be coated by a laminating method or by a brush coating method. Since the two fabric layers 11 are moved vertically in the horizontal plane during coating, it can help the adhesive to spread vertically and fluidly, which helps the efficiency of coating and reduces the time cost.

Preferably, at least one scraper member 43 is used to scrape off excess adhesive and adjust a thickness of the adhesive applied to the surface 10A. In present embodiment, the thickness is determined by the distance between the operating end of a scraper and the surface 10A, wherein the thickness of the adhesive on the surface 10A may be between 0.001 and 0.5 millimeters (mm). Preferably, an angle is formed between the operating end of the scraper and the surface 10A, and the angle is between 10 and 80 degrees;

S4. Next, providing a reaction condition such that the adhesive dries into a film and forms a bonding layer 22. For example, the reaction condition may be to provide an air flow such that the adhesive can be air dried to form the bonding layer 22. Or, the reaction condition may be a heating temperature such that the adhesive can be heat dried to form the bonding layer 22, wherein the heating temperature is between 120° C. and 180° C. Further, the heating temperature may be provided by an oven to which the three-dimensional fabric 10 may be transported after coating to complete the drying process;

S5. Providing a bonding temperature for bonding two of the combining layers 32 to two of the bonding layers 22. Wherein two of the combining layers 32 may be formed by a heat-compression laminating or laminating process, wherein the combining layer 32 is not limited to a single layer or multiple layers, in present embodiment, two of the combining layers 32 may be heat-compression laminated to two of the bonding layers 22, respectively, by using the roller pressing and heating technique;

S6. Next, the sheet of the cladding film 30 surrounds the side of the three-dimensional fabric 10, and at least a part of the two edges of the fabric layer 11 corresponding to the cladding film 30 is bonded to at least a part of the surface ring of the two bonding layers 22 to complete the manufacture of the inflatable product A. Wherein the bonding method is not limited, any bonding method that can achieve sealing and waterproofing and prevent gas leakage, such as high-frequency, ultrasonic, thermocompression welding, hot-jet welding or solvent treatment, all of which can achieve this effect.

Further, after the drying step S4. is completed, the three-dimensional fabric 10 can be guided out of the coating space 40 and stored by using the rewinding device 42, and then the step S5. and the step S6. can be continued as required.

Based on the above, the inflatable product A provided by the present invention has the following advantages in manufacture:
1. By guiding the three-dimensional fabric 10 vertically, the space occupied by horizontally transporting the three-dimensional fabric 10 can be effectively saved.
2. By applying the adhesive vertically, not only can both sides of the three-dimensional fabric 10 be coated at the same time, but the adhesive can also be spread vertically and fluidly, saving the coating process and time.
3. As the surface 10A of the two fabric layers 11 moves under tension, the two fabric layers 11 can be spread flat, which helps to improve the quality of adhesive coating.
4. As the surface 10A of the two fabric layers 11 moves under tension, when the adhesive is applied, the two fabric layers 11 will not move with mutual displacement along the coating direction.
5. Two fabric layers can be coated with the adhesive at the same time, so that the two fabric layers have the same rigidity, which helps to uniformly control the tension during the movement of the three-dimensional fabric and strengthens the flatness of the surface after coating.

The inflatable products provided by the present invention can be used in protective textiles, inflatable motorboats, temporary docks, buffer protective textiles, emergency ambulance docks, inflatable beds, stand-up paddles and jackets, and other inflatable protective materials and construction materials. By processing lighter and thinner adhesive application, it is expected to solve the problems of traditional manual application, slow production speed and uneven quality.

What is claimed is:

1. A method of coating to a three-dimensional fabric, comprising the steps of:
preparing a three-dimensional fabric having two fabric layers and a plurality of vertical yarns connected between the two fabric layers;
guiding the three-dimensional fabric with the two fabric layers vertically in the horizontal plane to a coating space;
applying an adhesive to the surface of the two fabric layers, and the adhesive spreading vertically and fluidly; and
providing a reaction condition such that the adhesive dries into a film and forms a bonding layer.

2. The method according to claim 1, wherein when the three-dimensional fabric moves in the coating space, a tension on the surface of the two fabric layers is between 5 and 25 kilograms (kg).

3. The method according to claim 2, wherein a scraper member scrapes off the adhesive from the surface to adjust the thickness of the adhesive.

4. The method according to claim 3, wherein the scraper member is a scraper, and an angle is formed between the operating end of the scraper and the surface, and the angle is between 10 and 80 degrees.

5. The method according to claim 1, wherein the reaction condition is an air flow or a heating temperature, wherein the heating temperature is between 120° C. and 180° C.

6. The method according to claim 1, wherein the three-dimensional fabric is in the form of a continuous web or a segment cut in advance.

7. The method according to claim 1, wherein the three-dimensional fabric is in the form of a continuous web, and at least one guide roller is used in the coating space to guide the three-dimensional fabric into or out of the coating space, wherein the speed of the three-dimensional fabric moving in the coating space is greater than 2 meters per minute.

8. The method according to claim 1, wherein a rewinding device is provided for rewinding the three-dimensional fabric after it leaves the coating space, and the rewinding device provides the tension to the fabric layers.

9. The method according to claim 1, wherein after the bonding layer is formed, a bonding temperature is provided for bonding two of the combining layers to two of the bonding layers.

10. The method according to claim 9, wherein the two combining layers are heat-compression laminated to two bonding layers, respectively, by using the roller pressing for bonding.

11. The method according to claim 9, wherein, after two of the combining layers are formed on two of the bonding layers, the sheet of a cladding film surrounds the side of the three-dimensional fabric, and at least a part of the two edges of the fabric layer corresponding to the cladding film is bonded to at least a part of the surface ring of the two bonding layers to complete the manufacture of the inflatable product.

12. An inflatable product, comprising a three-dimensional fabric having two fabric layers positioned up and down and a plurality of vertical yarns connected between the two such fabric layers, wherein the maximum distance between the two fabric layers when the three-dimensional fabric is expanded is limited by the length of the plurality of vertical yarns; and a cladding film surrounds the three-dimensional fabric, at least a part of the two edges of the cladding film corresponding to the two fabric layers, respectively, and being bonded to the ring of the three-dimensional fabric so that an inflatable space is defined between the three-dimensional fabric and the cladding film, when the inflatable space is filled with the air, the three-dimensional fabric is expanded and the two fabric layers are provided at the maximum distance from each other, wherein the two fabric layers correspond to a surface of the vertical yarn in sequence including:
a bonding layer is formed by an air drying or heat drying adhesive, the adhesive material being a thermosetting polyurethane or a hot melt adhesive; and
a combining layer is a waterproofing and air blocking fabric made of thermoplastic polyether polyurethane/thermoplastic polyester polyurethane, polyvinylchloride, rubber, or other elastomers.

13. The inflatable product according to claim 12, wherein the fabric layer includes a fabric tension range between 1000 and 2000 Newtons, a denier range between 100 and 1000 Dan, a warp per inch between 30 and 100 warp yarns per inch, and a fillings per inch between 20 and 80 warp yarns per inch.

14. The inflatable product according to claim 12, wherein the length of the vertical yarns is between 5 and 60 centimeters, and a yarn tension range of the vertical yarn is between 30 kilograms per 25 square centimeters and 250 kilograms per 25 square centimeters, wherein the distance between the vertical yarns is between 0.8 and 20 centimeters.

15. The inflatable product according to claim 14, wherein the lengths of the plurality of vertical yarns are different.

16. The inflatable product according to claim 14, wherein the vertical yarns are first set in rows with the distance range, and the vertical yarns set in rows is then distributed with a distance range of 5 to 10 cm between rows.

17. The inflatable product according to claim 12, wherein a viscosity range of the adhesive is between 5,000 and 100,000 centipoise.

18. The inflatable product according to claim 17, wherein the adhesive includes a viscosity modifier comprising acetone, isobutanol, glycol ether, butanone, ethyl acetate, or dimethylformamide.

19. The inflatable product according to claim 12, wherein the bonding layer and/or the combining layer comprises an antimicrobial agent, an electrical conductive agent, a flame retardant, a surface reinforcing agent, a foaming agent, a UV absorber, or a coloring agent.

20. The inflatable product according to claim 12, wherein the adhesive is selected from a group consisting of a polyurethane resin, 5 phr to 70 phr dimethylformamide, and 1 phr to 50 phr methyl ethyl ketone, with 0.1 phr to 40 phr of a bridging agent added, and the adhesive is formed by mixing a thermoplastic polyurethane resin with a bridging agent.
